(19) United States
(12) Patent Application Publication
(10) Pub. No.: US 2025/0083206 A1
(43) Pub. Date: Mar. 13, 2025

(54) ROTATING FUNNEL FEEDER

(71) Applicant: Hoffman Enclosures Inc., Anoka, MN (US)

(72) Inventors: Florian Hillen, Aachen (DE); Paul-Peter Valerius, Aachen (DE)

(21) Appl. No.: 18/828,362

(22) Filed: Sep. 9, 2024

Related U.S. Application Data
(60) Provisional application No. 63/581,518, filed on Sep. 8, 2023.

(51) Int. Cl. B21C 47/34; B21C 1/02; H01B 13/00

(52) U.S. Cl. CPC B21C 47/34; B21C 1/02; H01B 13/0036

(57) ABSTRACT

A feeder assembly for a machine for processing wire for electronic assemblies can include an entrance port to receive wire for processing by the machine, and a receiver that is secured to rotate relative to the entrance port during operation. The receiver includes a feed port that is in alignment with the entrance port of the machine along an insertion axis, and a funnel cavity that is connected to the feed port. The funnel cavity defines a funnel axis that is oriented obliquely relative to the insertion axis.

### CROSS-REFERENCE TO RELATED APPLICATIONS

This application claims priority to and incorporates by reference similarly titled U.S. provisional patent application No. 63/581,518, filed Sep. 8, 2023.

### BACKGROUND

Wires are often used for power distribution to transmit electricity from a source to an outlet in an electrical system. In some cases, cutting, stripping, crimping, or marking of wires may be necessary to join two separate wires during system assembly. The wires can be cut, stripped, crimped, and marked using various types of tools and machines to establish secure, reliable electrical connection.

### SUMMARY

In some examples, a feeder assembly for a machine for processing wire for electronic assemblies can include an entrance port to receive wire for processing by the machine, and a receiver that is secured to rotate relative to the entrance port during operation. The receiver can include a feed port that is in alignment with the entrance port of the machine along an insertion axis. A funnel cavity can be connected to the feed port at a first end and can be open at a second end to receive wire for processing. The funnel cavity can define a funnel axis that is oriented obliquely relative to the insertion axis.

In some examples, a method of processing wire with a machine can include inserting a free end of a wire into a funnel cavity of a receiver toward a feed port of the receiver. The feed port can define an insertion axis and the funnel cavity can define a funnel axis that is oriented obliquely relative to the insertion axis. The receiver can rotate about the insertion axis during insertion of the wire to guide the free end of the wire to the feed port. The free end of the wire can be advanced through the feed port along the insertion axis to an entrance port of the machine.

In some examples, a machine for processing wire can include a wire processing assembly, an entrance port and a receiver. The wire processing assembly can include one or more of a stripper-crimper assembly, a wire bundling assembly, a wire cutter assembly, or a wire labeling assembly, to process wire received into the machine. The entrance port can be aligned to guide the wire into the wire processing assembly. The receiver can include a funnel cavity with an open wider end to receive the wire into the receiver and an open narrower end opposite the open wider end. The funnel cavity can be rotationally asymmetrical relative to an insertion axis of the receiver. The receiver can include a feed port aligned with the open narrower end of the funnel cavity to receive the wire from the funnel cavity and align with the entrance port along the insertion axis to guide the wire from the funnel cavity to the entrance port.

In some examples, a method of processing wire with a machine can include rotating a receiver of the machine about an insertion axis to rotate a funnel cavity of the receiver. The funnel cavity can define a funnel axis that is oriented obliquely relative to the insertion axis. While the receiver rotates, to insert wire into the machine, inserting a free end of a wire into the funnel cavity of the receiver. Advancing the wire through the funnel cavity so that the wire can be deflected by the funnel cavity into a feed port of the receiver. Advancing the free end of the wire through the feed port along the insertion axis to an entrance port of the machine.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a front isometric view of a wire processing assembly, the wire processing assembly including a machine and a receiver according to an embodiment of the invention.

FIG. 2 is a front isometric view of the receiver of FIG. 1 in isolation.

FIG. 3 is a front elevational view of the receiver of FIG. 1.

FIG. 4 is a side cross-sectional view of the receiver of FIG. 1.

FIG. 5A is a front elevational view of another receiver, the receiver including a first receiver body that is separable from a second receiver body.

FIG. 5B is a front elevational view of yet another receiver, the receiver including an exit slot.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Conductive wires come in wide range of sizes, shapes, and insulation materials. Generally, a skilled electrician may require one or more standard tools (e.g., cable stripper, crimpers, pliers, tie wraps) to cut a wire to a desired length, to strip an insulation layer to expose a bare conductor, to crimp a wire by compressing the wire onto the bare conductor, to mark the wires (as appropriate), and to bundle the wires for an electronic assembly. (As used herein, “wire” generally refers to flexible, elongate conductors and should be understood to include single- and multi-strand (e.g., cable) configurations.) As described above, the process of cutting, stripping, crimping, and bundling the wires can be a laborious task. Accordingly, in operation, wires can be fed into an opening of a wiring machine or other wire processing assembly (e.g., automated wiring machine, semi-automated wiring machine) to perform cutting, stripping, crimping, or bundling of wires. However, this approach may result in wires being deformed once (or as) fed into the opening or becoming otherwise offset from a desired axis. This can result in defective results (e.g., strands of important conductors may be inadvertently cut).

Conventionally, mechanical gates or other assemblies are designed to form a centering unit in order to help align a wire that has predetermined parameters (e.g., thickness, length, etc.) about a center of the opening of the wiring machine. However, such centering units may typically include multiple individual components and can be highly complex to build. For example, in some approaches a free end of a predetermined wire can be gripped by machine and slid into an opening using a machine carriage. However, the gripping may induce undesirable bending which may offset the wires from the central of the opening. Additionally, the free end of the wire cannot be gripped without providing sufficient free length of the wire which may lead to processing complications and material waste. Further, conventional designs for the wiring machine also may not provide for a wire centering mechanism that can be usefully applied for various sizes (e.g., diameter) and shapes of wire.

The technology disclosed herein can provide a wire funnel feeder that can address the problems noted above, or various others associated with cutting, stripping, crimping, bundling, or otherwise processing various types of wires. More specifically, the funnel feeder can enable flexible wires to be fed into a machine (e.g., any variety of known wire processing machines, or others) about a central axis. For example, a wire funnel feeder or a receiver disclosed herein can be secured to rotate relative to an entrance port of the machine during operation. The rotation of the receiver can help to center the wires about an insertion axis and guide the wires into the desired opening in a predictable and repeatable way (e.g., with a predetermined orientation). More specifically, the entrance port of a machine can be aligned with a feed port of the receiver along an insertion axis, and the feed port can be connected to a funnel cavity. The funnel cavity may include a funnel axis that is offset at an angle from the insertion axis to ensure that the wire is fed properly through the entrance port of the machine during operation.

Generally, the features discussed above and below can collectively (or individually) help to align the wires while increasing the efficiency and consistency of cutting, stripping, and crimping of wires. Other benefits will be also apparent to those of skill in the art in view of the detailed discussion below.

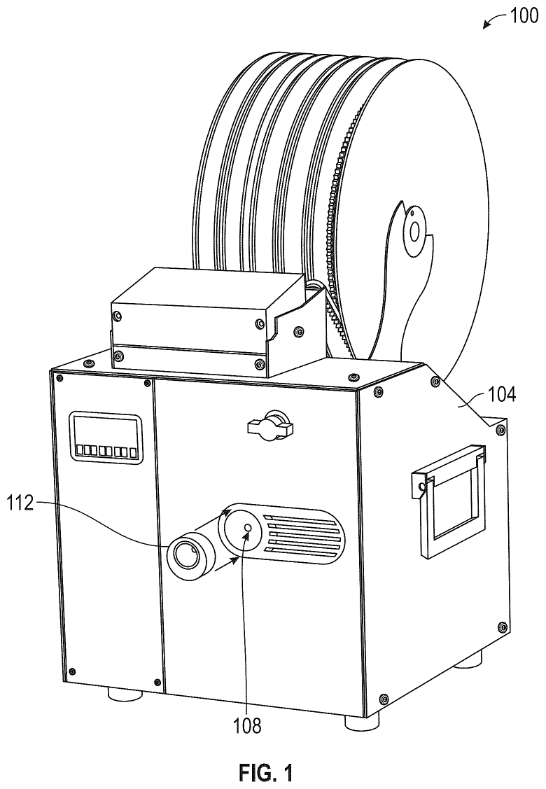

The concepts described herein can be practiced in various machines that perform wire processing, including as detailed below. For example, FIG. 1 illustrates a wire processing assembly 100. The wire processing assembly 100 can be a stripper-crimper assembly, a wire bundling assembly, a wire cutter assembly, a wire labeling assembly, or a combination thereof, or any variety of other machines known in the art for processing wires or wire bundles. The wire processing assembly 100 of the present disclosure includes a machine 104 with an entrance port 108 and a receiver 112 that is secured to rotate relative to the entrance port during operation. In the illustrated example, the receiver 112 can be mounted onto the entrance port 108 (e.g., shown by the arrows of the illustrated figure), including by a snap-fit or other engagement between a spindle of the receiver 112 (e.g., as discussed below) a collar, sleeve, or other structure surrounding the opening of the entrance port 108. Generally, the machine 104 may also include one or more internal subassemblies (not shown) to perform one or more wire-processing tasks, including various wire-processing subassemblies generally known in the art. Accordingly, the entrance port 108 may be an opening of (or to) the subassembly, to receive wire for processing by the subassembly.

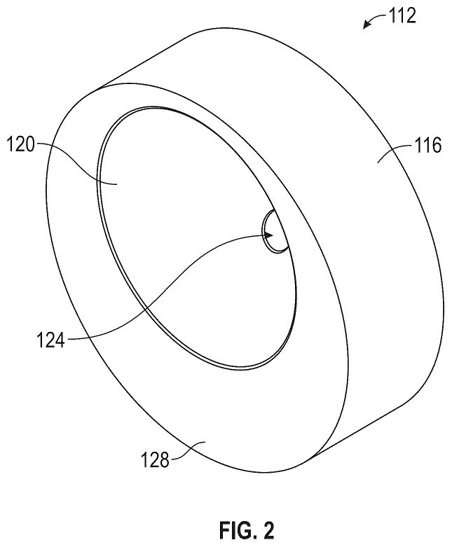

FIGS. 2-4 illustrate an example configuration of the receiver 112 according to an embodiment of the invention. The shape of a body 116 of the receiver 112 of the present embodiment is cylindrical (e.g., circular profile) but can include various shapes in other examples. The body 116 of the receiver 112 includes a funnel cavity 120 that is connected to a feed port 124, and the connection between the funnel cavity 120 and the feed port 124 extends between a front surface 128 and a rearmost surface 132 (See FIG. 4).

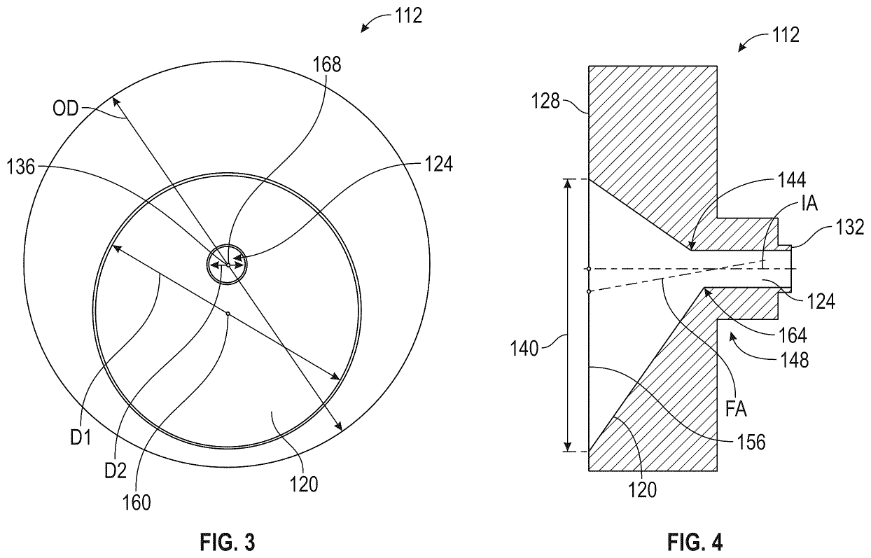

Referring to FIG. 3, the body 116 defines an outer diameter OD of the receiver 112. The feed port 124 of the receiver 112 is disposed concentric to the outer diameter OD of the receiver 112. Unlike the feed port 124, the funnel cavity 120 is not concentric with both the outer diameter OD of the body 116 and the feed port 124 of the receiver. Rather, the funnel cavity 120 is at an offset relative to a center 136 of the receiver 112. Accordingly, as the receiver 112 rotates about a central axis (e.g., through the feed port 124), the funnel cavity 120 rotates simultaneously but asymmetrically relative the central axis.

In particular, in the illustrated example, a wide end 140 of the funnel cavity 120 can be defined by a first diameter D1 and a narrow end 144 of the funnel cavity 120 can be defined by a second diameter D2 corresponding to the feed port 124. In the illustrated embodiment, the funnel cavity 120 can transition smoothly into the feed port 124 to provide a continuous connection between the funnel cavity 120 and the feed port 124.

FIG. 4 further illustrates the offset of the funnel cavity 120 and the connection to the feed port 124 of the receiver 112. The feed port 124 defines an insertion axis IA that is centered on the receiver 112 and the funnel cavity 120 defines a funnel axis FA that is off centered on the receiver. In particular, in the illustrated embodiment, the funnel axis FA is oriented obliquely relative to the insertion axis IA. In other words, the funnel cavity 120 can be rotationally asymmetrical relative to the insertion axis IA while also being rotationally symmetrical relative to the funnel axis FA (i.e., having rotational symmetry about the funnel axis FA over a length of the funnel axis FA). In this regard, as shown, although the side walls of the funnel cavity 120 may be symmetrically arranged in general relative to the funnel axis FA, the side walls may extend different lengths from an apex of the funnel cavity 120 (i.e., at the feed port 124, as shown) at different locations about the circumference. Thus, for example, the funnel cavity 120 may be symmetrical about the funnel axis FA and asymmetrical about the insertion axis IA, while also accommodating a generally planar front profile of the body of the receiver 112.

As described above, the feed port 124 of the receiver 112 is in alignment with the entrance port 108 of the machine 104 about the insertion axis IA., when the body 116 of the receiver 112 is secured to rotate relative to the entrance port 108 of the machine 104 during operation. Accordingly, as the receiver 112 is rotated about the insertion axis IA, the wire fed into the funnel cavity 120 can be guided by the asymmetrical rotation of the funnel cavity 120 to ensure that the free end of the wire moves into alignment with the entrance port 108 (and the insertion axis IA).

In some examples, the securement between the entrance port 108 and the feed port 124 is accomplished by a spindle 148. For example, as shown in FIG. 4, the spindle 148 can exhibit a tiered diameter relative to a radial thickness of the body 116. In the illustrated embodiment, the feed port 124 extends fully through the spindle 148 of the receiver 112 between the rearmost surface 132 and the narrow end 144 of the funnel cavity 120. The spindle 148, for example, can be received into a relevant machine to secure the receiver 112 to the relevant wire-processing machine and provide an interface for transmittal of rotational force from the machine to the receiver 112 (and particularly to the funnel cavity 120). For example, the spindle 148 can be clamped, snap-engaged, pinned, or otherwise secured to a rotating collar, socket or other member of the relevant machine according to various approaches generally known in the art for connecting co-rotating parts.

As mentioned above, the funnel cavity 120 is defined by a cylindrical body extending radially and axially outwardly relative to the spindle 148 between the wide end 140 and the narrow end 144. Further, in the illustrated example, the wide end 140 of the funnel cavity 120 defines an entrance profile 156 (e.g., a circular profile, as shown) that is defined by the first diameter D1 (or maximum width) and a first center 160 along the funnel axis FA. Similarly, the feed port 124, at the narrow end 144 of the funnel cavity 120, defines a feed profile 164 (e.g., a circular profile, as shown) corresponding to the second diameter D2 and a second center 168 along the insertion axis IA (e.g., coincident with the center 136 of the receiver 112 overall). In particular, the first center 160 is thus radially offset from the second center 168.

The resulting offset angle between the funnel axis FA and the insertion axis IA may be varied as needed, including according to an expected rotational speed of the receiver 112, a speed the wire is to be fed through the feed port 124, or a combination thereof. In some examples, the offset angle may be about 10 degrees, or about 20 degrees, or about 30 degrees, or about 40 degrees, or about 50 degrees, or about 60 degrees, or about 70 degrees, or about 80 degrees.

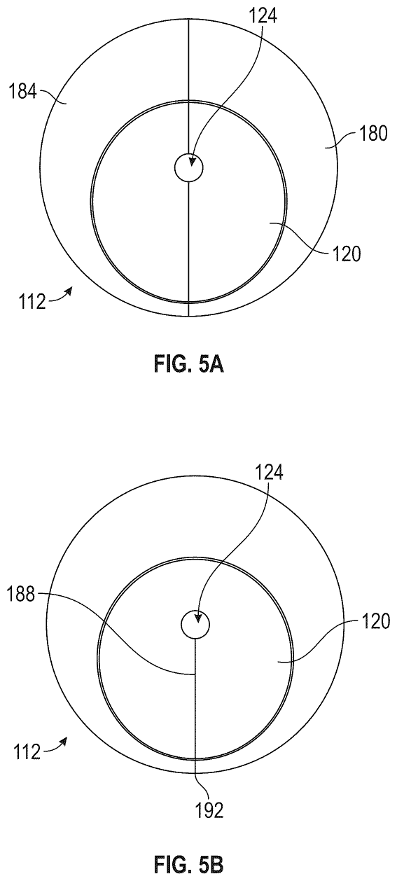

In some cases, wires may need to be removed from a processing machine through an entrance opening after processing. However, pulling the wires from the feed port 124 may in some cases be detrimental to the processed free end of the wire (e.g., may adversely impact labels attached to the wire ends). Referring to FIG. 5A, in some embodiments, the receiver 112 may include a first receiver body 180 and a second receiver body 184 that are separable from each other, so that operators can radially remove the wire from the feed port 124. For instance, the first and second receiver body 180, 184 (e.g., symmetrical half bodies, as shown) can be coupled by via a living hinge (not shown) or other suitable joining mechanism. In some examples, the first and second receiver body 180, 184 may include a spring-loaded system to cause either the first or the second receiver body 180, 184 to push open for removal of wire (or to biasingly secure the bodies 180, 184 together).

Alternatively (or additionally), referring to FIG. 5B, the bodies 180, 184 of the receiver 112 in some embodiments may include an exit slot 188 that extends from the feed port 124 to a radial periphery 192 of the receiver 112. In different examples, the exit slot 188 can be disposed at various angles relative to the feed port 124. For example, the exit slot 188 can be disposed diagonally between the feed port 124 and the radial periphery 192, can extend to bisect the funnel cavity 120 (as shown). The processed free end of wires can thus be removed through the exit slot 188 (e.g., rather than axially withdrawn) to allow sufficient clearance, prevent damage to conductor cores disposed at the free end, or otherwise improve processing operations.

Referring again to FIGS. 1 and 2, during operation, a free end of a wire can be inserted into the funnel cavity 120 of the receiver 112 toward the feed port 124 of the receiver 112. During this insertion, the receiver can be rotated about the insertion axis IA (see FIG. 4) to guide the free end of the wire to the feed port 124. In particular, the generally asymmetrical configuration of the receiver 112 can thus result in the walls of the funnel cavity 120 deflecting or otherwise directing the wire to the feed port 124 despite potential initial misalignment of the wire. Correspondingly, it may be easier for a user to align a wire with the relatively large entrance opening of the funnel cavity 120, with the rotational movement of the receiver 112 then combining with simple insertion force on the wire (from the user) to ensure appropriate alignment of the wire with the narrower feed port 124, and so on. Thus, the free end of the wire can be easily advanced, as guided by the funnel cavity 120 and the feed port 124, with appropriately alignment to move into the entrance port 108 of the machine 104. As needed, after the machine 104 performs the relevant task(s) (e.g., cutting, stripping, crimping, bundling or a combination thereof), the wire can then be removed from the receiver 112 (e.g., extended fully through the receiver 112 or withdrawn therefrom axially or otherwise). In some examples, the wire can be removed from the exit slot 188 (see FIG. 5B) after processing. In some examples, the first or second receiver bodies 180, 184 (see FIG. 5A) can be separated to remove the wire from the receiver 112.

Although particular examples above relate to wire processing, other applications of the disclosed technology are also possible. For example, some configurations of a funnel feeder can be used to capture and guide a wide variety of bendable, elongate work pieces into small diameter openings (or other targets) for processing machines of a wide variety of types. In this regard, discussion herein particular to wire processing should be understood to generally also apply to other operations relating to other (non-wire) components.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

Also as used herein, unless otherwise specified or limited, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screws, other fasteners, or adhesive to hold separately formed pieces together, is an integral (and integrally formed) element. In contrast, an element formed from multiple pieces that are separately formed initially then later fastened together, is not an integral (or integrally formed) element.

Also as used herein, unless otherwise limited or defined, “or” indicates a non-exclusive list of components or operations that can be present in any variety of combinations, rather than an exclusive list of components that are available only as alternatives to each other. For example, a list of A, B, or C indicates options of: A; B; C; A and B; A and C; B and C; and A, B, and C. Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as “either,” “one of,” “only one of,” or “exactly one of”

Also as used herein, unless otherwise limited or defined, “about” refers to a range of values that is within plus or minus 5% of a reference value, inclusive. For example, “about 100” indicates a range of 95 to 105, inclusive. Generally, unless otherwise noted, any references herein to a numerical range are intended to include the endpoints of the range.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A feeder assembly for a machine for processing wire for electronic assemblies, the feeder assembly comprising:
an entrance port to receive wire for processing by the machine; and
a receiver secured to relative to the entrance port, to rotate during operation, the receiver including:
a feed port in alignment with the entrance port along an insertion axis; and
a funnel cavity that is connected to the feed port at a first end and is open at a second end to receive the wire for processing and guide the wire to the entrance port via the feed port, the funnel cavity defining a funnel axis that is oriented obliquely relative to the insertion axis.

2. The feeder assembly of claim 1, wherein the funnel cavity is rotationally asymmetrical relative to the insertion axis.

3. The feeder assembly of claim 2, wherein the funnel cavity is rotationally symmetrical relative to the funnel axis.

4. The feeder assembly of claim 1, wherein the entrance port extends through a spindle of the receiver; and
wherein the funnel cavity is defined by a rotatable body extending radially and axially outwardly, relative to the spindle.

5. The feeder assembly of claim 1, wherein, the second end of the funnel cavity defines an entrance profile with a first center; and
wherein the feed port defines a feed profile with a second center that is radially offset from the first center, relative to a perspective along the insertion axis.

6. The feeder assembly of claim 5, wherein the entrance profile is a circular entrance profile and the feed profile is a circular feed profile.

7. The feeder assembly of claim 1, wherein the feed port is centered on the receiver and the funnel cavity is off-centered on the receiver.

8. The feeder assembly of claim 1, wherein the receiver further includes an exit slot extending from the feed port to a radial periphery of the receiver.

9. The feeder assembly of claim 1, wherein the receiver includes a first receiver body and a second receiver body that are separable from each other to radially remove wire from the feed port.

10. A machine for processing wire, the machine comprising:
a wire processing assembly that includes one or more of a stripper-crimper assembly, a wire bundling assembly, a wire cutter assembly, or a wire labeling assembly, to process wire received into the machine;
an entrance port aligned to guide the wire into the wire processing assembly; and
a receiver that includes:
a funnel cavity with an open wider end to receive the wire into the receiver and an open narrower end opposite the open wider end, the funnel cavity being rotationally asymmetrical relative to an insertion axis of the receiver; and
a feed port aligned with the open narrower end of the funnel cavity to receive the wire from the funnel cavity, and aligned with the entrance port along the insertion axis to guide the wire from the funnel cavity to the entrance port.

11. The machine of claim 10, wherein the funnel cavity defines a funnel axis that is oriented obliquely relative to the insertion axis.

12. The machine of claim 11, wherein the funnel cavity is rotationally symmetrical relative to the funnel axis.

13. The machine of claim 10, wherein the receiver is an integrally formed body.

14. The machine of claim 13, wherein the feed port extends along the insertion axis through a spindle of the integrally formed body that is secured to the machine for powered rotation.

15. The machine of claim 10, wherein a center of the open wider end of the funnel is radially offset from the insertion axis.

16. The machine of claim 10, wherein the receiver includes one or more of a slot or a plurality of receiver bodies separable from each other, for removal of a wire from the receiver in a radial direction relative to the insertion axis.

17. A method of processing wire with a machine, the method comprising:
rotating a receiver of the machine about an insertion axis to rotate a funnel cavity of the receiver, the funnel cavity defining a funnel axis that is oriented obliquely relative to the insertion axis;
while the receiver rotates:
to insert wire into the machine, inserting a free end of a wire into the funnel cavity of the receiver; and
advancing the wire through the funnel cavity so that the wire is deflected by the funnel cavity into a feed port of the receiver; and
advancing the free end of the wire through the feed port along the insertion axis to an entrance port of the machine.

18. The method of claim 17, wherein the receiver is an integrally formed body that includes the funnel cavity and the feed port.

19. The method of claim 17, further comprising:
removing the wire from the receiver through an exit slot that extends from the feed port to a radial periphery of the receiver.

20. The method of claim 17, further comprising:
removing the wire from the receiver by separating a first receiver body of the receiver from a second receiver body of the receiver.
